(19) United States
(12) Patent Application Publication
(10) Pub. No.: US 2016/0359255 A1
(43) Pub. Date: Dec. 8, 2016

(54) PLUG, AND TOOL AND METHOD FOR THE PRODUCTION THEREOF

(71) Applicant: ERNI PRODUCTION GMBH & CO. KG, Adelberg (DE)

(72) Inventor: Jürgen LAPPÖHN, Gammelshausen (DE)

(21) Appl. No.: 15/106,762

(22) PCT Filed: Dec. 19, 2014
(86) PCT No.: PCT/DE2014/100460

§ 371 Date: Jun. 20, 2016

(30) Foreign Application Priority Data
Dec. 20, 2013 (DE) 10 2013 021 752.0

(51) Int. Cl. H01R 13/405; H01R 43/24; H01R 13/04; B29C 45/00

(52) U.S. Cl. CPC H01R 13/405; B29C 45/0025; B29C 45/0046; H01R 43/24; H01R 13/04; B29K 2105/0067

(57) ABSTRACT

The invention relates to a plug (4) having an electrical insulating body (41) comprising a plurality of through-openings and a plurality of electrical contact elements (42a, 42b, 42c, 42d, 42e, 42f), wherein each electrical contact element (42a, 42b, 42c, 42d, 42e, 42f) is arranged partially in a through-opening in the electrical insulating body (41). At least one through-opening has a rectangular cross-section with a plurality of opening interfering contours which are arranged point-symmetrically on the through-opening. A method for producing the plug (4) comprises the provision of a tool having a base region and a plurality of cores protruding from the base region, the introduction of a molten polymer mass into the tool, the flow direction of the polymer mass being directed such that no polymer flows converge along a line which connects the center points of two cores to each other, allowing the molten polymer mass to solidify, removal of the tool in order to obtain an electrical insulating body (41) which consists of the polymer mass and has through-openings, and the introduction of an electrical contact element (42a, 42b, 42c, 42d, 42e, 42f) into each of the through-openings. At least one core of a tool equipped for carrying out this method has a rectangular cross-section with a plurality of core interfering contours, which are arranged point-symmetrically on the core and which direct the flow direction of the polymer mass.

The present invention relates to an electrical plug connector. Furthermore, the invention relates to a tool for the production of the plug connector and a method for the production of the plug connector which in particular can be implemented using the tool according to the invention.

### PRIOR ART

Conventional plug connectors comprise an insulating body in which a plurality of electrical contact elements are fastened. Blade elements or spring elements can be used as electrical contact elements. The production of the insulating body occurs by a molten plastic being introduced into a tool for the production of the insulating body, for example by means of injection moulding. Liquid crystal polymers (LCP), for example, are used as thermoplastic plastics. In order to define openings in the insulating body into which the electrical contact elements can be introduced, the tool has so-called cores on a base plate. These cores have a usually rectangular cross-section and correspond in shape and dimensions to that part of the electrical contact elements which are later to be introduced into the insulating body in order to produce the plug connector. The molten plastic flows firstly onto the cores during the production of the insulating body. Each core divides the flow of the plastic melt into two partial flows which flow together again behind the core. At the point, where the two partial flows converge, a weld seam fissure can be formed in the insulating body during cooling and solidifying of the plastic melt. This has the consequence that the completed plug connector can break at the weld seam fissure during later mechanical loading.

The object of the present invention is to provide an electrical plug connector which does not have the weld seam fissure known from prior art, and therefore has higher mechanical resilience than conventional plug connectors. Furthermore, an object of the invention is to provide a tool and a method for the production of the plug connector according to the invention.

### DISCLOSURE OF THE INVENTION

This object is solved by the plug connector according to the invention. This has an electrical insulating body with a plurality of through-openings and a plurality of electrical contact elements. Each electrical contact element is arranged partially in a through-opening of the electrical insulating body. At least one through-opening has a rectangular cross-section with a plurality of opening interfering contours. An opening interfering contour is here understood, according to the invention, to be a contour which interferes with the rectangular cross-section of the opening in such a way that the rectangular cross-section of the through-opening is extended. If the opening interfering contour is polygonal, this leads to the at least one through-opening having a polygonal cross-section with at least four corners which is not a rectangular cross-section. For example, it can be a cross-section in the shape of a parallelogram in which no angle measures 90°. Fundamentally, the opening interfering contour can, however, also have one or more arched sides.

Each electrical contact element preferably has a section with a rectangular cross-section, wherein the section is arranged in the through-opening of the insulating body. This enables a secure fastening of the electrical contact element in the insulating body. The rectangular cross-section of the contact element corresponds in particular to the rectangular cross-section of the through-opening without the opening interfering contours, such that this is filled by the section of the electrical contact element. The region of the through-opening defined by the opening interfering contour is not filled, however, by the section of the electrical contact element.

The electrical contact elements are, according to the invention, in particular, blade elements. Alternatively, the plug connector according to the invention can, however, also is designed in such a way that the electrical contact elements are spring elements.

Each opening interfering contour is preferably located on a side of the through-opening which is facing towards another through-opening. It is possible in one embodiment of the invention that the insulating body has at least one further opening which only has an opening interfering contour which is located on a side of the through-opening which is not facing towards another through-opening, but instead an edge of the insulating body. In another preferred embodiment of the invention, each opening interfering contour is located on a side of the through-opening which is facing towards another through-opening, such that no opening interfering contour is facing towards an edge of the insulating body.

It is more preferred that the plug connector according to the invention has at least one first opening interfering contour on a first through-opening, said first opening interfering contour facing towards a second through-opening, and that the plug connector has at least one second opening interfering contour on the second through-opening, said second opening interfering contour facing towards the first through-opening.

This leads to the first opening interfering contour and the second opening interfering contour facing towards each other.

More preferably, each side of the first opening interfering contour runs in parallel to a side of the second opening interfering contour. This leads to a point-symmetrical shape of the two opening interfering contours. Such a more preferred arrangement of the opening interfering contours is, for example, present if the opening cross-section, including the opening interfering contours, has the shape of a parallelogram in which no angle measures 90°.

The through-opening has a plurality of opening interfering contours which are arranged point-symmetrically on the through-opening. Preferably, however, they are not arranged mirror-symmetrically on the through-opening. Mirror-symmetrical is understood, according to the invention, such that the through-opening is able to be transferred in itself by only a single mirroring operation along a mirror plane, wherein this mirror plane does not lie in a plane lying in the electrical insulating body, through which the openings pass orthogonally.

The tool according to the invention for the production of the plug connector has a base region and a plurality of cores protruding from the base region. Here, cores are understood, according to the invention, to be bodies connected firmly to the base region which can direct the flow of a polymer melt and are impermeable to this. At least one core has a rectangular cross-section with a plurality of core interfering contours. The term core interfering contour is here, just as the term opening interfering contour, to be understood in relation to the plug connector according to the invention, such that the core interfering contour extends the cross-section of the core beyond its rectangular base shape.

It is preferred that each of the core interfering contours is located on a side of the core which is facing towards another core. In one embodiment of the tool according to the invention, this can have at least one further core which has a core interfering contour which is not facing towards another core, but rather an edge of the base region of the tool. In another embodiment of the tool according to the invention, each core interfering contour which is located on a side of a core is facing towards another core such that no core interfering contour is facing towards an edge of the base region of the tool. Core interfering contours which are facing towards other cores are suitable for causing frictions of a polymer melt between the cores.

More preferably, the tool has at least one first core interfering contour on a first core, said first core interfering contour facing towards a second core. It has at least one second core interfering contour on the second core, said second core interfering contour facing towards a first core such that the first core interfering contour and the second core interfering contour are facing towards each other. Particularly strong frictions of a polymer melt can hereby be generated.

Most preferably, each side of the first core interfering contour runs in parallel to a side of the second core interfering contour. The two core interfering contours are hereby point-symmetrical to each other, which enables a simple production of the tool.

The plurality of core interfering contours are arranged point-symmetrically on the core. However, they are preferably not arranged mirror-symmetrically on the core. Mirror-symmetrical is understood, according to the invention, such that the core is able to be transferred in itself by only a single mirror operation along a mirror plane, wherein this mirror plane is not orthogonal on the longitudinal axis of the core.

The tool according to the invention is in particular configured to receive a melt of a thermoplastic polymer. For this purpose, the base region and the cores in particular consist of a material which can withstand a temperature of at least 350° C. without softening or thermal damage.

The method according to the invention for the production of a plug connector comprises the following steps:
providing a tool having a base region and a plurality of cores protruding from the base region,
introducing a molten polymer mass into the tool, wherein the flow direction of the polymer mass is directed such that no plastic flows converge along a line which connects the centre points of two cores to each other,
allowing the molten plastic mass to solidify,
removing the tool in order to obtain an electrical insulating body which consists of the plastic mass and has through-openings, and
introducing, respectively, an electrical contact element into each of the through-openings.

The polymer mass contains, in particular, filamentous filler materials. In order to achieve a good electrical insulating effect of the insulating body, electrically non-conductive filamentous filler materials, such as, for example, glass fibres, are preferred.

By preventing plastic flows from converging along the line which connects the central points of two cores to each other, the formation of weld seam fissures can be prevented.

The tool is preferably a tool according to the invention, wherein the flow direction of the polymer mass is directed by means of the at least one core interfering contour. In this way, the shape of the core according to the invention of the tool according to the invention enables the implementation of the method according to the invention. However, through-openings are hereby generated in the insulating body which have an extension, due to the core interfering contours of the cores, of the cross-section beyond the rectangular cross-section which is necessary to receive the electrical contact elements. The rectangular basic cross-section of the through-openings ensures, however, a sufficiently secure fastening of the electrical contact elements in the through-openings.

It is more preferred that the plastic mass is introduced into the tool from a direction in which at least one core interfering contour of the tool points. In this way, the core interfering contour can cause a diversion of the polymer flow.

### BRIEF DESCRIPTION OF THE DRAWINGS

Exemplary embodiments of the invention are depicted in the drawings and are explained in more detail in the following description.

FIG. 1 shows an isometric depiction of a tool for the production of a plug connector according to prior art.

FIG. 2 shows a top view onto the tool according to FIG. 1 during the production of an electrical insulating body.

FIG. 3 shows a top view onto an electrical insulating body of a plug connector according to prior art.

FIG. 4 shows an electrical contact element according to prior art.

FIG. 5 shows an isometric depiction of a part of a plug connector according to prior art.

FIG. 6 shows a top view onto another tool according to prior art during the production of an electrical insulating body.

FIG. 7 shows a top view onto another electrical insulating body of a plug connector according to prior art.

FIG. 8 shows an isometric depiction of a part of another plug connector according to prior art.

FIG. 9 shows an isometric depiction of a tool for the production of a plug connector according to a first embodiment of the invention.

FIG. 10 shows a top view onto the tool according to FIG. 6 during the production of an electrical insulating body.

FIG. 11 shows a top view onto the electrical insulating body of a plug connector according to the first embodiment of the invention.

FIG. 12 shows an isometric depiction of a part of a plug connector according to the first embodiment of the invention.

FIG. 13 shows an isometric depiction of a tool for the production of a plug connector according to a second embodiment of the invention.

FIG. 14 shows a top view onto the tool according to FIG. 10 during the production of an electrical insulating body.

FIG. 15 shows a top view onto an electrical insulating body of a plug connector according to the second embodiment of the invention.

FIG. 16 shows an isometric view of a part of a plug connector according to the second embodiment of the invention.

FIG. 17 shows a top view onto an electrical insulating body of a plug connector according to a third embodiment of the invention.

FIG. 18 shows an isometric view of a plug connector according to the third embodiment of the invention.

### EMBODIMENTS OF THE INVENTION

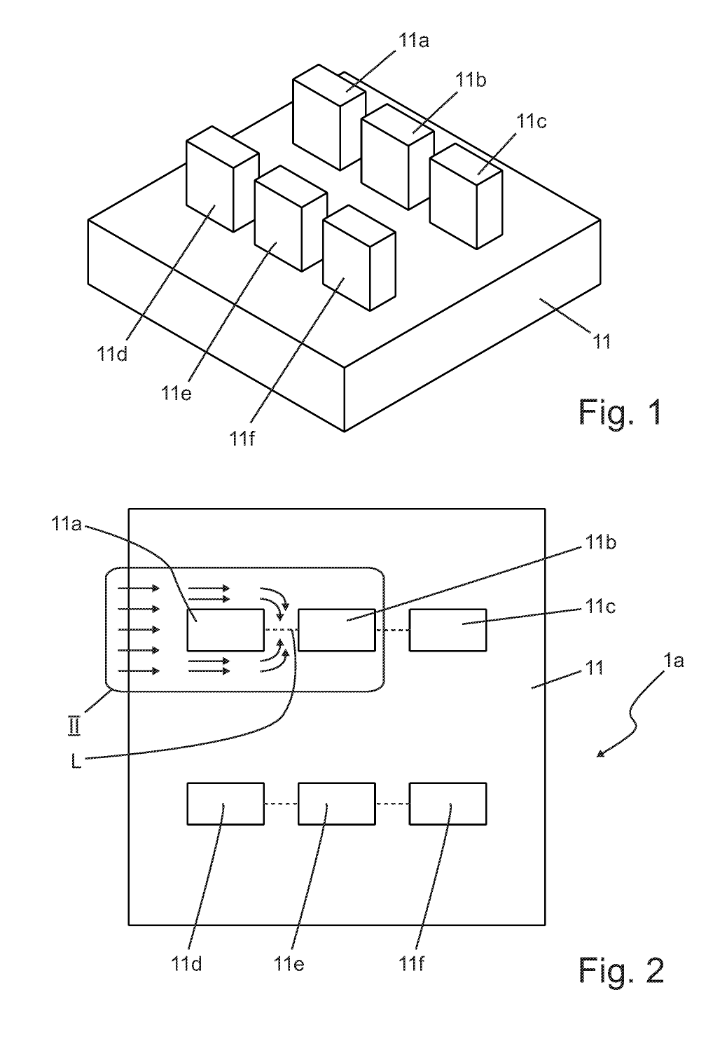

A first conventional tool 1a for the production of an electrical plug connector, as is depicted in FIGS. 1 and 2, has a rectangular base region 11 on which six cores 11a, 11b, 11c, 11d, 11e, 11f are arranged in two parallel rows, wherein the first row has the first three cores 11a, 11b, 11c and the second row has the further three cores 11d, 11e, 11f. The base region 11 and the cores 11a, 11b, 11c, 11d, 11e, 11f are formed in one piece of a metal. The cores 11a, 11b, 11c, 11d, 11e, 11f have, respectively, a rectangular cross-section, wherein their length is greater along one of the two rows than their width transversely to one of the two rows.

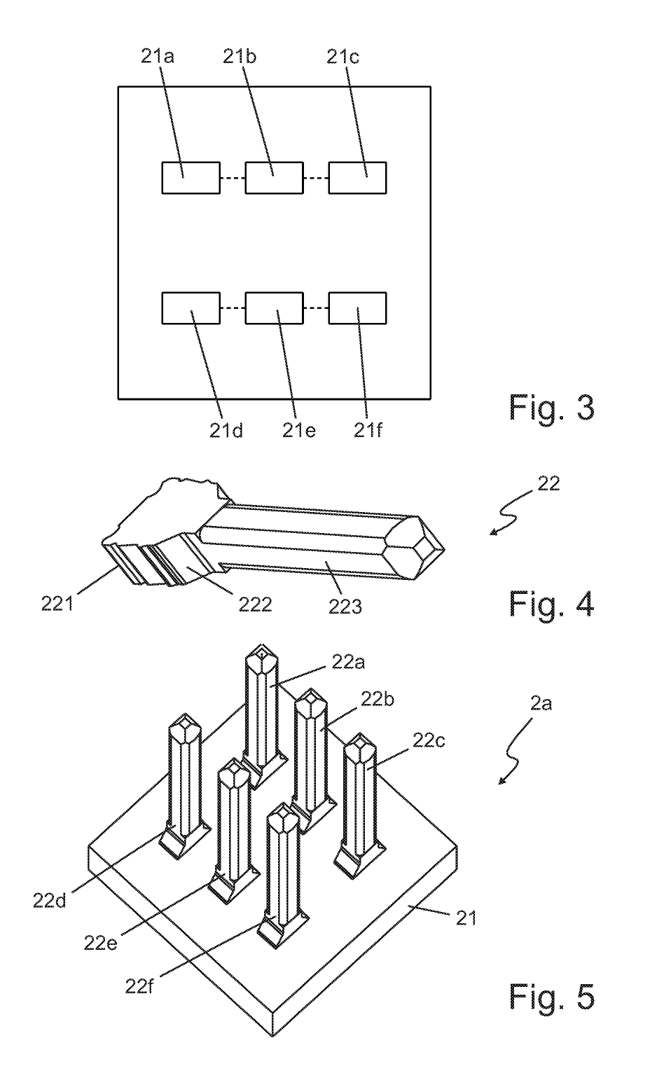

A thermoplastic LCP polymer melt is introduced into this tool 1a by means of injection moulding, typically at a temperature of 350° C. and a pressure of 100 MPa. In the region II in FIG. 2, it is depicted by means of arrows how the polymer flow flowing into the tool 1a is divided by a core 11a into two partial flows, which flow together again between this core 11a and the core 11b lying behind this in the flow direction and converge on a line L, which connects the centre points of these two cores 11a, 11b to each other. A “skin” of partially solidified melt is formed on the surface of the polymer melt and therefore also on the melt front, due to cooling. If the melt fronts with their skins flow together, therefore, during cooling of the polymer melt, a weld seam fissure is formed along the line L. Analogue weld seam fissures are formed likewise between all further pairs of cores which are consecutive in the flow direction of the polymer melt, i.e. also between the cores 11b and 11c, the cores 11d and 11e and the cores 11e and 11f. After cooling and solidifying of the polymer melt, an insulating body 21 depicted in FIG. 3 can be removed from the tool 1. It has through-openings 21a, 21b, 21c, 21d, 21e, 21f at the positions from which the cores 11a, 11b, 11c, 11d, 11e, 11f have kept away the polymer melt. The electrical insulating body 21 is weakened by weld seam fissure which are located between the through-openings 21a, and 21b, between 21b and 21c, between 21d and 21e and between 21e and 21f.

To produce an electrical plug connector, electrical contact elements 22 are introduced into the through-openings 21a, 21b, 21c, 21d, 21e, 21f. These electrical contact elements 22 can be designed as blade elements, as is depicted in FIG. 4. Such a blade element consists of a section 221 with a rectangular cross-section, a section 222 in which a tapering of the cross-section takes place and a blade section 223. Six of such contact elements 22a, 22b, 22c, 22d, 22e, 22f are positioned in the electrical insulating body 21 such that the section 221 with a rectangular cross-section respectively fills one of the through-openings 21a, 21b, 21c, 21d, 21e, 21f. For this purpose, the cross-section of this section 221 corresponds to the cross-section of the through-openings 21a, 21b, 21c, 21d, 21e, 21f. The thus obtained conventional plug connector 2a is partially depicted in FIG. 5.

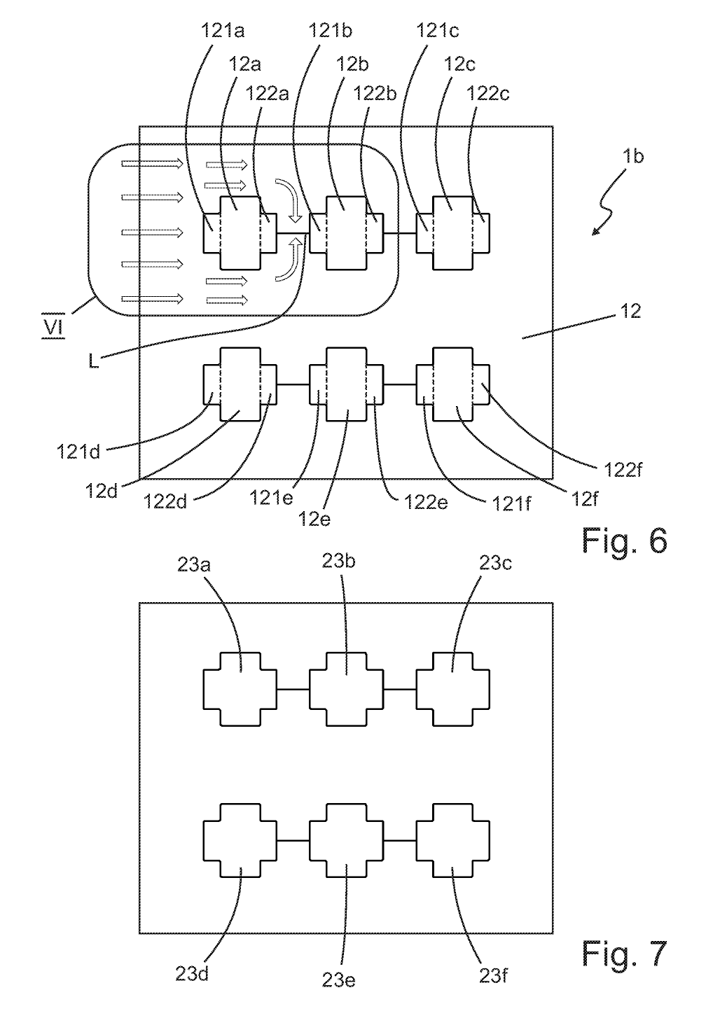

A second conventional tool 1b is depicted in FIG. 6. This has a base region 12 with six cores 12a, 12b, 12c, 12d, 12e, 12f which are arranged in the same way as the cores 11a, 11b, 11c, 11d, 11e, 11f of the first conventional tool 1a. Along the two rows of cores 12a, 12b, 12c, 12d, 12e, 12f, each of the cores 12a, 12b, 12c, 12d, 12e, 12f has a rectangular core interfering contour 121a, 122a, 121b, 122b, 121c, 122c, 121d, 122d, 121e, 122e, 121f, 122f on the left side thereof and on the right side thereof. The cores thereby have, respectively, a cross-shaped cross-section which is respectively mirror-symmetrical to a horizontal mirror plane, to a vertical mirror plane as well as to a diagonal mirror plane rotated by 45° relative to these two mirror planes.

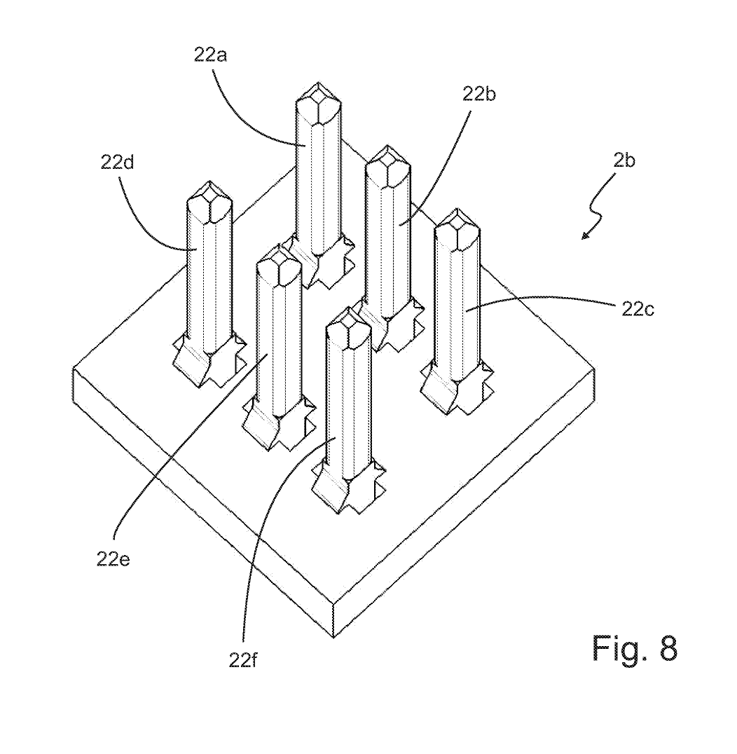

A thermoplastic LCP polymer melt is introduced into this tool 1b under the same conditions as into the first conventional tool 1a. In the region VI in FIG. 6, it is depicted by means of arrows how the polymer flow flowing into the tool 1b is divided by a core 12a into two partial flows which flow together again between this core 12a and the core 12b lying behind this in the flow direction and converge on a line L which connects the centre points of these two cores 12a, 12b to each other. During cooling of the polymer melt, a weld seam fissure formed along this line L. Analogue weld seam fissures are formed likewise between all further pairs of cores which are consecutive in the flow direction of the polymer melt, i.e. also between the cores 12b and 12c, the cores 12d and 12e and the cores 12e and 12f. After cooling and solidifying of the polymer melt, an insulating body depicted in FIG. 7 can be removed from the tool 1b. The plug connector has through-openings 23a, 23b, 23c, 23d, 23e, 23f at the positions from which the cores 12a, 12b, 12c, 12d, 12e, 12f have kept away the polymer melt. The electrical insulating body is weakened by weld seam fissures which are located between the through-openings 23a and 23b, between 23b and 23c, between 23d and 23e and between 23e and 23f. The mirror-symmetrical core interfering contours 121a, 122a, 121b, 122b, 121c, 122c, 121d, 122d, 121e, 122e, 121f, 122f have no influence on the formation of the weld seam fissures compared to the insulating body which was produced by means of the conventional tool 1a. By introducing the electrical contact elements 22a, 22b, 22c, 22d, 22e, 22f which correspond in their design to conventional electrical contact elements 22, the electrical plug connector 2b partially depicted in FIG. 8 is obtained. Here, the section 221 with a rectangular cross-section of each electrical contact element 22a, 22b, 22c, 22d, 22e, 22f is fastened respectively in the rectangular region of the through-openings 12a, 12b, 12c, 12d, 12e, 12f, while the opening interfering contours remain unfilled.

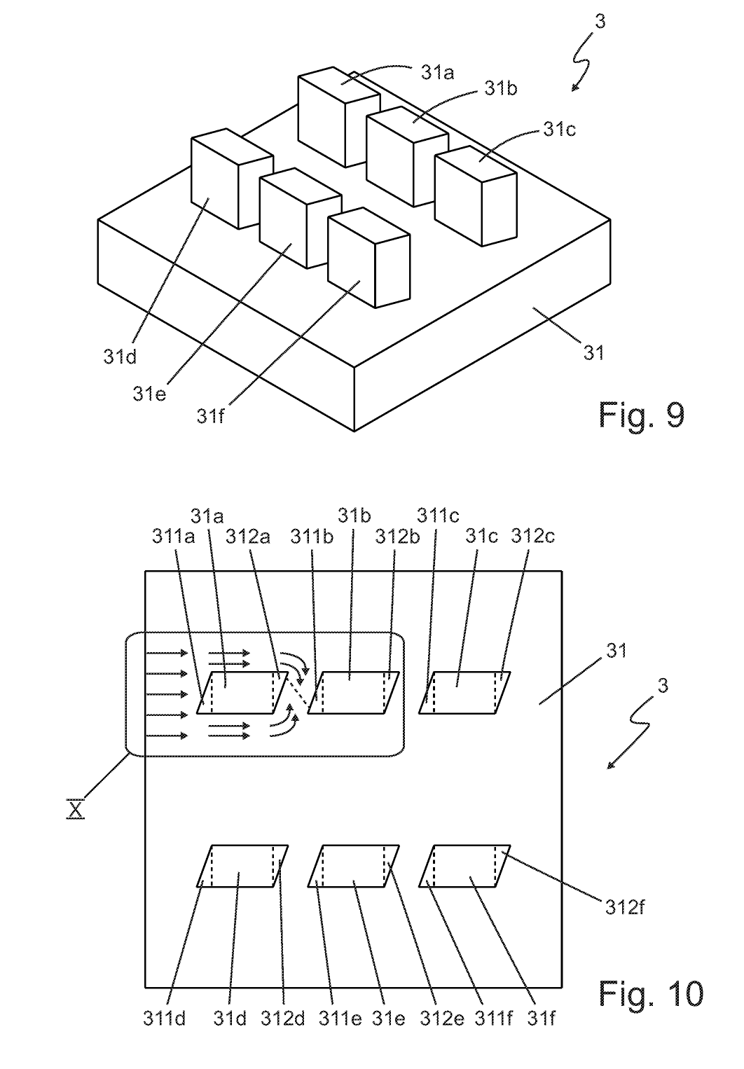

A tool 3 according to a first embodiment of the invention is depicted in FIGS. 9 and 10. This has a base region 31 with six cores 31a, 31b, 31c, 31d, 31e, 31f which are arranged in the same way as the cores 11a, 11b, 11c, 11d, 11e, 11f of the conventional tool 1. Along the two rows of cores 31a, 31b, 31c, 31d, 31e, 31f, each of the cores 31a, 31b, 31c, 31d, 31e, 31f has a triangular core interfering contour 311a, 311b, 311c, 311d, 311e, 311f on the left side thereof over its entire width in the top view according to FIG. 10. A further triangular core interfering contour 312a, 312b, 312c, 312d, 312e, 312f which is point-symmetrical to this, but not mirror-symmetrical, is located on the opposite right side. The cores 31a, 31b, 31c, 31d, 31e, 31f thereby have, respectively, a parallelogram-shaped cross-section, wherein no angle of the parallelogram measures 90°.

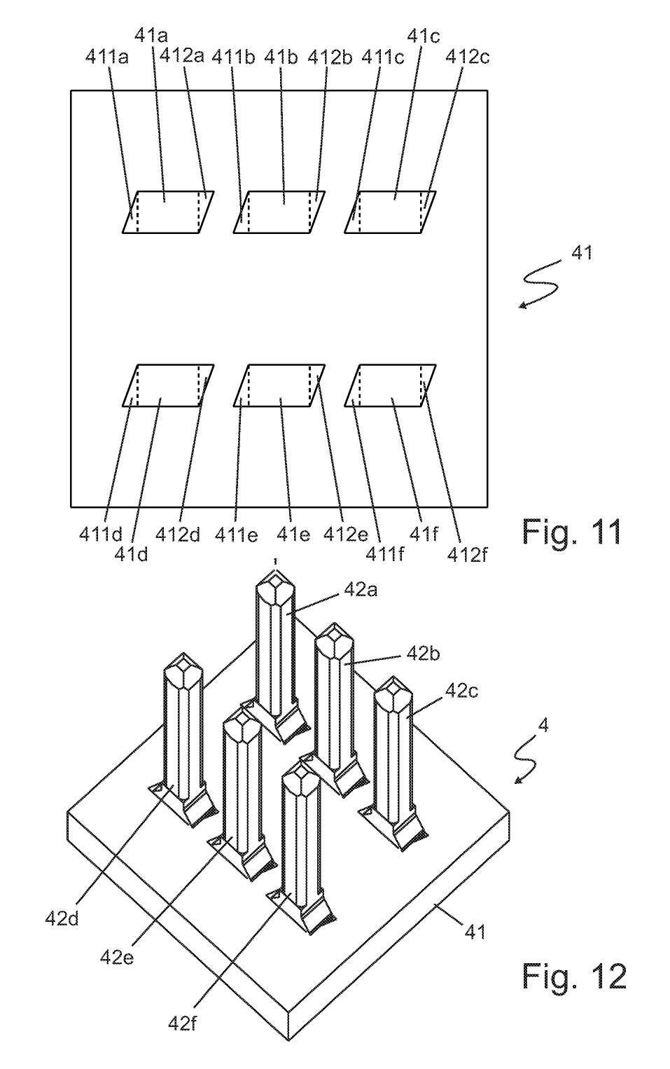

If a polymer melt is introduced in a conventional manner into the tool 3, the flow thereof is firstly divided into partial flows in a known way, as is depicted in the region X in FIG. 10. If these partial flows flow together again between two cores 31a, 31b along a line illustrated as dashed, however, a friction or similar of the melting fronts occurs due to the core interfering contours 312a, 311b of the two cores 31a, 31b located in the region where they flow together. The skin formed on the melt front is here ruptured during the friction by filamentous filler materials contained in the polymer melt such as, for example, glass fibres. No weld seam fissure can hereby be formed. An insulating body 41 can therefore be removed from the tool which is not mechanically weakened by weld seam fissures. As is depicted in FIG. 11, the through-openings 41a, 41b, 41c, 41d, 41e, 41f which the cores 31a, 31b, 31c, 31d, 31e, 31f have generated in the insulating body 41 do not have a rectangular, but rather a parallelogram-shaped cross-section. This is composed respectively from a rectangular basic cross-section and opening interfering contours 411a, 412a, 411b, 412b, 411c, 412c, 411d, 412d, 411e, 412e, 411f, 412f which reflect the core interfering contours 311a, 312a, 311b, 312b, 311c, 312c, 311d, 312d, 311e, 312e, 311f, 312f of the tool 3. By introducing electrical contact elements 42a, 42b, 42c, 42d, 42e, 42f which correspond in their design to conventional electrical contact elements 22, the electrical plug connector 4 partially depicted in FIG. 12 is obtained. Here, the section 221 with a rectangular cross-section of each electrical contact element 42a, 42b, 42c, 42d, 42e, 42f is fastened respectively in the rectangular region of the through-openings 41a, 41b, 41c, 41d, 41e, 41f, while the opening interfering contours 411a, 412a, 411b, 412b, 411c, 412c, 411d, 412d, 411e, 412e, 411f, 412f remain unfilled. This has, however, no negative consequences on the functionality of the electrical plug connector 4.

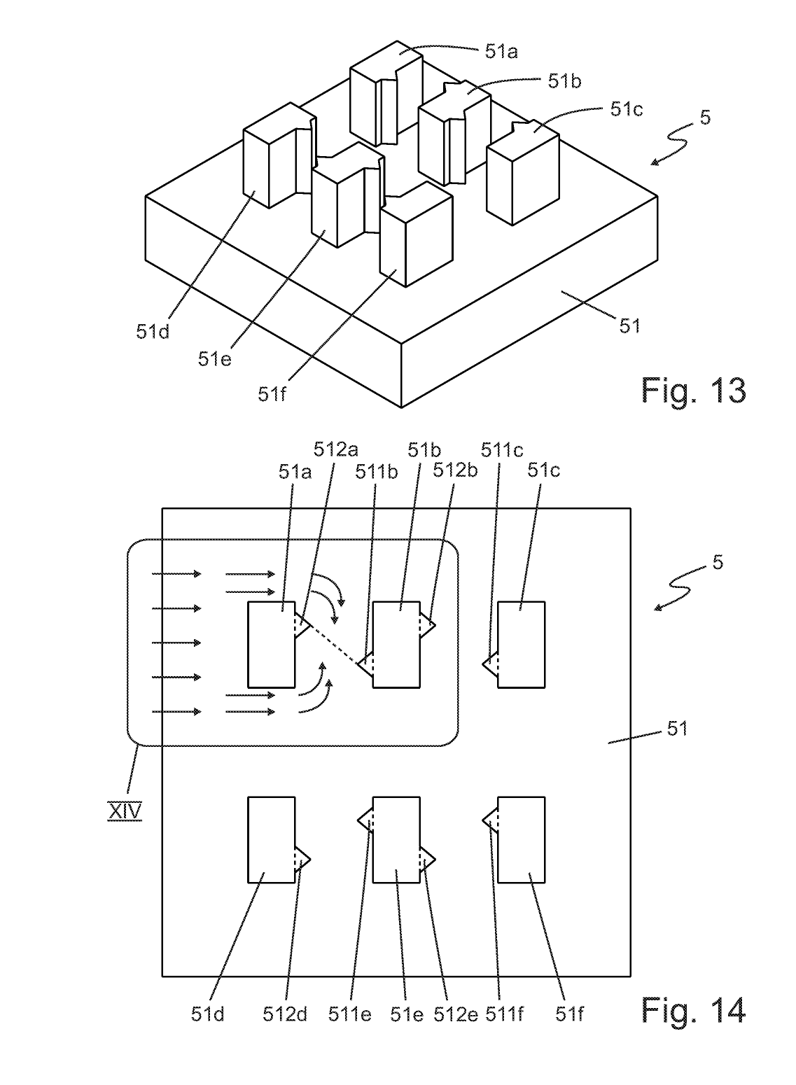

A tool 5 for the production of an electrical plug connector according to a second embodiment of the invention is shown in FIGS. 13 and 14. A rectangular base region 51 has six cores 51a, 51b, 51c, 51d, 51e, 51f arranged in a conventional way, wherein the length thereof along one of the two rows is smaller than the width thereof transversely to one of the two rows. The cores 51a, 51b, 51c, 51d, 51e, 51f have core interfering contours 512a, 511b, 512b, 511c, 512d, 511e, 512e, 511f which are arranged such that they are facing exclusively towards other cores 51a, 51b, 51c, 51d, 51e, 51f within the same row, though not towards an edge of the base region 51. The core interfering contours 512a, 511b, 512b, 511c, 512d, 511e, 512e, 511f are respectively of triangular shape and have a smaller width than the core 51a, 51b, 51c, 51d, 51e, 51f on which they are arranged. Within the first row of cores 51a, 51b, 51c, the first core 51a has a core interfering contour 512a which is facing towards the second core 51b. The third core 51c has a core interfering contour 511c which is facing towards the second core 51b. The second core 51b has a first core interfering contour 511b which is facing towards the first core 51a and a second core interfering contour 512e which is facing towards the third core 51c. The two core interfering contours 511b, 512b of the second core 51b are arranged point-symmetrically to each other, but not mirror-symmetrically. The pairs of core interfering contours 512a, 511b and 512b, 511c respectively facing each other are respectively arranged such that one respective side of each core interfering contour of one of the pairs 512a, 511b and 512b, 511c lies on a mutual straight line with a side of the other core interfering contour of this pair. The core interfering contours 512d, 511e, 512e, 511f in the second row of cores 51d, 51e, 51f are arranged mirror-symmetrically to the core interfering contours 512a, 511b, 512b, 511c of the cores 51a, 51b, 51c of the first row.

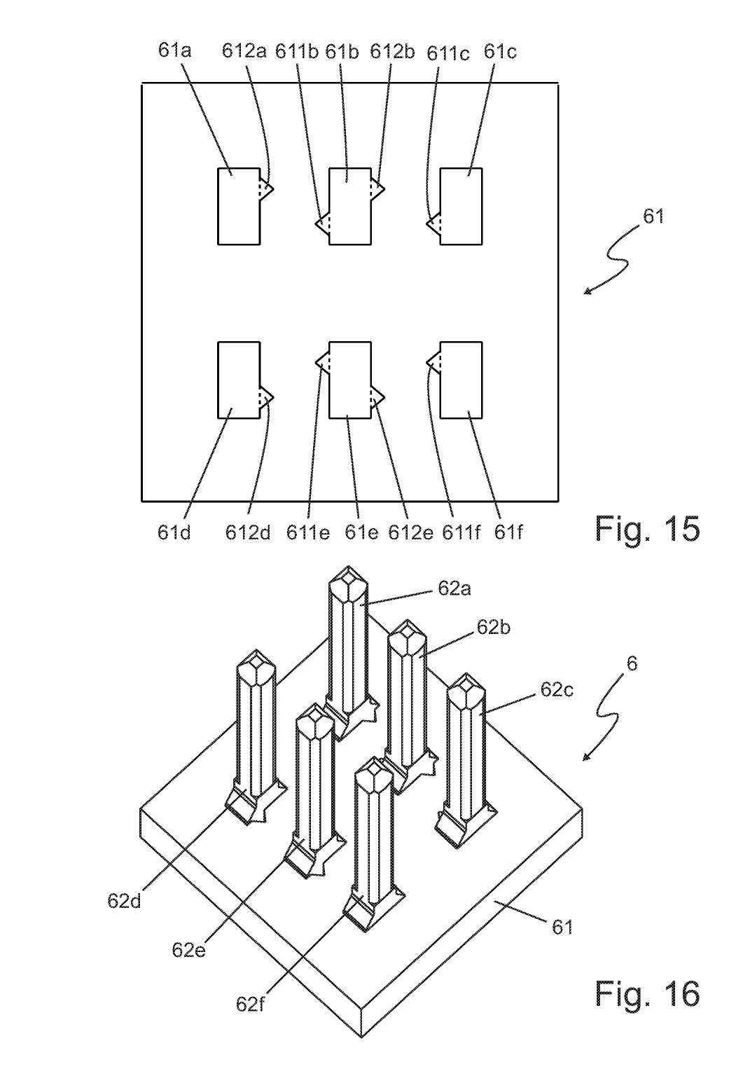

If a molten polymer mass flows into the tool 5, then the flow thereof, as is shown in region XIV in FIG. 14, is firstly divided into two partial flows in a conventional way by a core 51a, said partial flows then flowing together again between two cores 51a, 51b along a line illustrated as dashed. The core interfering contours 512a, 511b of the two cores 51a, 51b arranged in this region where the polymer flows flow together here cause a friction of the polymer flows such that no weld seam fissures can form in this exemplary embodiment of the invention. Therefore an insulating body 61 can be removed from the tool 5 which is free from mechanical interferences. As is depicted in FIG. 15, this insulating body 61 has through-openings 61a, 61b, 61c, 61d, 61e, 61f which, as in the first exemplary embodiment of the invention, have opening interfering contours 612a, 611b, 612b, 611c, 612d, 611e, 612e, 611f which reflect the shape of the core interfering contours 512a, 511b, 512b, 511c, 512d, 511e, 512e, 511f of the cores 51a, 51b, 51c, 51d, 51e, 51f. In order to obtain an electrical plug connector 6 partially depicted in FIG. 16, electrical contact elements 62a, 62b, 62c, 62d, 62e, 62f are inserted into the through-openings 61a, 61b, 61c, 61d, 61e, 61f in such a way that the section 221 with a rectangular cross-section fills the rectangular region of the through-openings 61a, 61b, 61c, 61d, 61e, 61f. The opening interfering contours 612a, 611b, 612b, 611c, 612d, 611e, 612e, 611f are not filled and remain open, as in the first embodiment of the plug connector according to the invention, without hereby weakening the mechanical stability of the electrical plug connector 6.

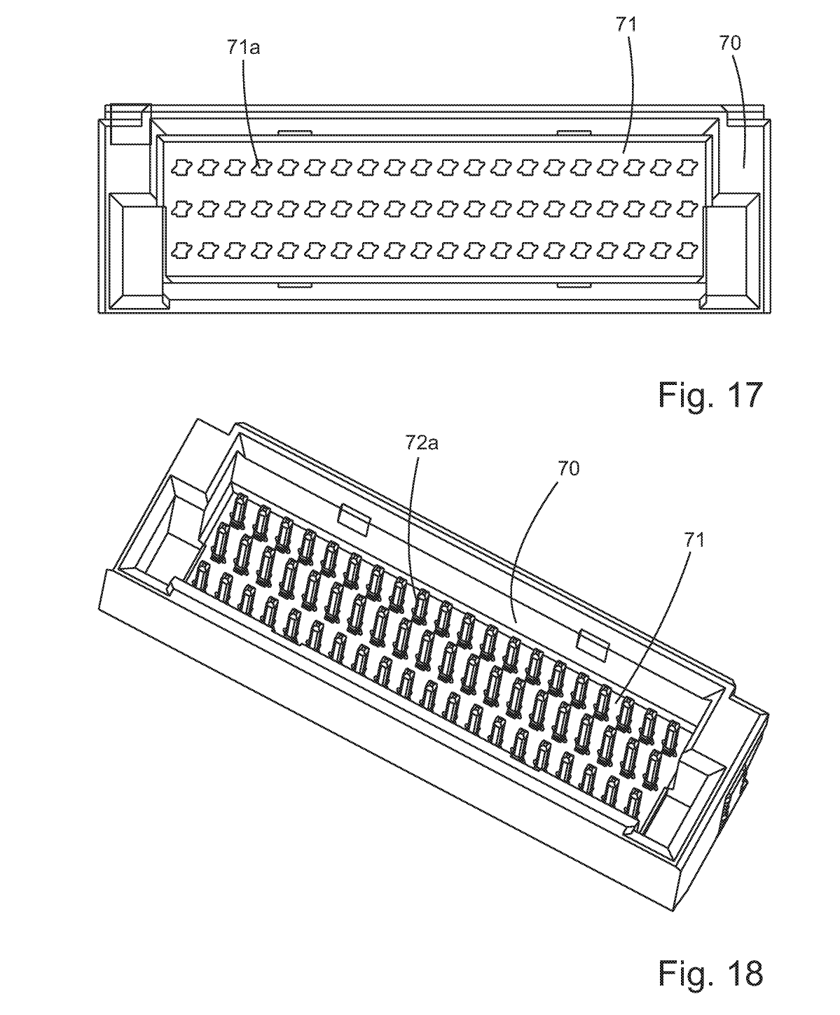

In a third embodiment of the invention, an insulating body 71 depicted in FIG. 17 is produced, the opening interfering contours of which have a cross-section, the triangular shape of which differs slightly from the triangular shape of the opening interfering contours of the second embodiment. The insulating body 71 is arranged in a housing 70 and has three parallel rows of through-openings 71a. By electrical contact elements 72a being inserted into the through-openings 71a in such a way that the section 221 thereof with a rectangular cross-section fills the rectangular region of the through-openings 71a and the opening interfering contours are here not filled, the electrical plug connector is obtained which is depicted in FIG. 18.

The electrical plug connector 4, 6 according to the three embodiments of the invention can be produced by means of the tools according to the invention by applying known methods of plug connector production and have increased mechanical resilience compared to conventional plug connectors 2a, 2b.

1. Plug connector (4, 6) having an electrical insulating body (41, 61) with a plurality of through-openings (41a, 41b, 41c, 41d, 41e, 41f, 61a, 61b, 61c, 61d, 61e, 61f) and a plurality of electrical contact elements (42a, 42b, 42c, 42d, 42e, 42f, 62a, 62b, 62c, 62d, 62e, 62f), wherein each electrical contact element (42a, 42b, 42c, 42d, 42e, 42f, 62a, 62b, 62c, 62d, 62e, 62f) is arranged partially in a through-opening (41a, 41b, 41c, 41d, 41e, 41f, 61a, 61b, 61c, 61d, 61e, 61f) of the electrical insulating body (41, 61), characterised in that at least one through-opening (41a, 41b, 41c, 41d, 41e, 41f, 61a, 61b, 61c, 61d, 61e, 61f) has a rectangular cross-section with a plurality of opening interfering contours (411a, 412a, 411b, 412b, 411c, 412c, 411d, 412d, 411e, 412e, 411f, 412f, 612a, 611b, 612b, 611c, 612d, 611e, 612e, 611f) which are arranged point-symmetrically on the through-opening (41a, 41b, 41c, 41d, 41e, 41f, 61b, 61e).

2. Plug connector (4, 6) according to claim 1, characterised in that each electrical contact element (42a, 42b, 42c, 42d, 42e, 42f, 62a, 62b, 62c, 62d, 62e, 62f) has a section (221) with a rectangular cross-section, wherein the section (221) is arranged in the through-opening (41a, 41b, 41c, 41d, 41e, 41f, 61a, 61b, 61c, 61d, 61e, 61f) of the insulating body (41, 61).

3. Plug connector (4, 6) according to claim 1 or 2, characterised in that the electrical contact elements (42a, 42b, 42c, 42d, 42e, 42f, 62a, 62b, 62c, 62d, 62e, 62f) are blade elements.

4. Plug connector (4, 6) according to one of claims 1 to 3, characterised in that each opening interfering contour (411a, 412a, 411b, 412b, 411c, 412c, 411d, 412d, 411e, 412e, 411f, 412f, 612a, 611b, 612b, 611c, 612d, 611e, 612e, 611f) is located on a side of the through-opening (41a, 41b, 41c, 41d, 41e, 41f, 61a, 61b, 61c, 61d, 61e, 61f) which is facing towards another through-opening (41a, 41b, 41c, 41d, 41e, 41f, 61a, 61b, 61c, 61d, 61e, 61f).

5. Plug connector (4, 6) according to claim 4, characterised in that it has at least one first opening interfering contour (411b, 411c, 411e, 411f, 611b, 611c, 611e, 611f) on a first through-opening (41b, 41c, 41e, 41f, 61b, 61c, 61e, 61f), said first opening interfering contour facing towards a second through-opening (41a, 41b, 41d, 41e, 61a, 61b, 61d, 61e), and has at least one second opening interfering contour (412a, 412b, 412d, 412e, 612a, 612b, 612d, 612e) on the second through-opening (41a, 41b, 41d, 41e, 61a, 61b, 61d, 61e), said second opening interfering contour facing towards the first through-opening (41b, 41c, 41e, 41f, 61b, 61c, 61e, 61f).

6. Plug connector (4, 6) according to claim 5, characterised in that each side of the first opening interfering contour (411b, 411c, 411e, 411f, 611b, 611c, 611e, 611f) runs in parallel to a side of the second opening interfering contour (412a, 412b, 412d, 412e, 612a, 612b, 612d, 612e).

7. Plug connector (4, 6) according to one of claims 1 to 3, characterised in that the plurality of opening interfering contours (411a, 412a, 411b, 412b, 411c, 412c, 411d, 412d, 411e, 412e, 411f, 412f, 611b, 612b, 611e, 612e) are not arranged mirror-symmetrically on the through-opening (41a, 41b, 41c, 41d, 41e, 41f, 61b, 61e).

8. Tool (3, 5) for the production of a plug connector (4, 6), having a base region (31, 51) and a plurality of cores (31a, 31b, 31c, 31d, 31e, 31f, 51a, 51b, 51c, 51d, 51e, 51f) protruding from the base region (31, 51), characterised in that at least one core (31a, 31b, 31c, 31d, 31e, 31f, 51a, 51b, 51c, 51d, 51e, 51f) has a rectangular cross-section with a plurality of core interfering contours (311a, 312a, 311b, 312b, 311c, 312c, 311d, 312d, 311e, 312e, 311f, 312f, 512a, 511b, 512b, 511c, 512d, 511e, 512e, 511f) which are arranged point-symmetrically on the core (31a, 31b, 31c, 31d, 31e, 31f, 51b, 51e).

9. Tool (3, 5) according to claim 8, characterised in that each core interfering contour (312a, 311b, 312b, 311c, 312d, 311e, 312e, 311f, 512a, 511b, 512b, 511c, 512d, 511e, 512e, 511f) is located on a side of a core (31a, 31b, 31c, 31d, 31e, 31f, 51a, 51b, 51c, 51d, 51e, 51f) which is facing towards another core (31a, 31b, 31c, 31d, 31e, 31f, 51a, 51b, 51c, 51d, 51e, 51f).

10. Tool (3, 5) according to claim 8 or 9, characterised in that it has at least one first core interfering contour (311b, 311c, 311e, 311f, 511b, 511c, 511e, 511f) on a first core (31b, 31c, 31e, 31f, 51b, 51c, 51e, 51f), said first core interfering contour facing towards a second core (31a, 31b, 31d, 31e, 51a, 51b, 51d, 51e), and has at least one second core interfering contour (312a, 312b, 312d, 312e, 512a, 512b, 512d, 512e) on the second core (31a, 31b, 31d, 31e, 51a, 51b, 51d, 51e), said second core interfering contour facing towards the first core (31b, 31c, 31e, 31f, 51b, 51c, 51e, 51f).

11. Tool (3, 5) according to claim 10, characterised in that each side of the first core interfering contour (311b, 311c, 311e, 311f, 511b, 511c, 511e, 511f) runs in parallel to a side of the second core interfering contour (312a, 312b, 312d, 312e, 512a, 512b, 512d, 512e).

12. Tool (3, 5) according to one of claims 8 to 10, characterised in that the plurality of core interfering contours (311a, 312a, 311b, 312b, 311c, 312c, 311d, 312d, 311e, 312e, 311f, 312f, 511b, 512b, 511e, 512e) are not arranged mirror-symmetrically on the core (31a, 31b, 31c, 31d, 31e, 31f, 51b, 51e).

13. Method for the production of a plug connector (4, 6), comprising the following steps:
providing a tool (3, 5) having a base region (31, 51) and a plurality of cores (31a, 31b, 31c, 31d, 31e, 31f, 51a, 51b, 51c, 51d, 51e, 51f) protruding from the base region,
introducing a molten polymer mass into the tool (3, 5), wherein the flow direction of the polymer mass is directed such that no polymer flows converge along a line (L) which connects the centre points of two cores (31a, 31b, 31c, 31d, 31e, 31f, 51a, 51b, 51c, 51d, 51e, 51f) to each other,
allowing the molten polymer mass to solidify,
removing the tool (3, 5) in order to obtain an electrical insulating body (41, 61) which consists of the polymer mass and has through-openings (41a, 41b, 41c, 41d, 41e, 41f, 61a, 61b, 61c, 61d, 61e, 61f), and
introducing, respectively, an electrical contact element (42a, 42b, 42c, 42d, 42e, 42f, 62a, 62b, 62c, 62d, 62e, 62f) into each of the through-openings (41a, 41b, 41c, 41d, 41e, 41f, 61a, 61b, 61c, 61d, 61e, 61f).

14. Method according to claim 13, characterised in that the tool (3, 5) is a tool according to one of claims 8 to 12, wherein the flow direction of the polymer mass is directed by means of the at least one core interfering contour (311a, 312a, 311b, 312b, 311c, 312c, 311d, 312d, 311e, 312e, 311f, 312f, 512a, 511b, 512b, 511c, 512d, 511e, 512e, 511f).

15. Method according to claim 14, characterised in that the polymer mass is introduced into the tool (3, 5) from a direction in which at least one core interfering contour (311a, 312a, 311b, 312b, 311c, 312c, 311d, 312d, 311e, 312e, 311f, 312f, 512a, 511b, 512b, 511c, 512d, 511e, 512e, 511f) of the tool (3, 5) points.
